(19) United States
(12) Patent Application Publication
(10) Pub. No.: US 2004/0075548 A1
(43) Pub. Date: Apr. 22, 2004

(54) Monitoring a remote body detection system of a door

(76) Inventors: Ryan P. Beggs, Dubuque, IA (US); James C. Boerger, Franksville, WI (US); Glenn R. Manich, Mequon, WI (US); Lucas I. Paruch, Dubuque, IA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/274,791

(22) Filed: Oct. 21, 2002

(51) Int. Cl. G08B 19/00

(52) U.S. Cl. 340/522

(57) ABSTRACT

A method for recognizing potential faults of one or more remote body detectors of a door can be applied to a wide variety of conventional detectors that may not necessarily have a self-monitoring feature themselves. The method may be counter-based, timer-based or a combination of the two. In some embodiments, the method involves comparing the behavior of a detector to that of another detector at the door or to the activity of another door-related event, such as the door opening or closing. In some cases, the activity of a single detector is compared to a predetermined acceptable range of activity over a given period.

### BACKGROUND OF THE INVENTION

1. Field of the Invention

The subject invention generally pertains to a system for detecting the presence of a body near a doorway and more specifically to a method of monitoring such a system.

2. Description of Related Art

There are a wide variety of available devices for detecting the presence of a body, such as a person or object, near a doorway. Such detection devices, known as photoelectric eyes, proximity sensors, motion detectors, etc. operate under various principles including, ultrasonics; active and passive detection of infrared radiation; detection of electromagnetic radiation (including sensing radio waves or sensing changes in capacitance or inductance); and detecting a Doppler shift in microwaves; and lasers. In response to sensing a nearby body, the detector may simply trigger a light or an alarm, or the device may affect the operation of a door.

In door applications, a detection device generally falls under one of two categories: a door opener or a door interrupter. A door opener triggers the opening of a door for an approaching body, such as a shopper entering or leaving a store. A door interrupter, on the other hand, prevents an already open door from accidentally closing against a body that may be in the doorway or within the generally vertical plane defined by the path of the door's travel.

Door openers typically monitor an area in front of the door where the approaching body is expected to travel. Since door openers are more for convenience than safety, the monitored area is a general vicinity rather than a tightly controlled, well defined area in front of the door. Often, the monitored area does not extend the full width of the doorway. So, in many cases, a body may avoid detection by approaching the door from the side, thereby reaching the door without the door being automatically opened. Such operation may be acceptable for a door opener, but a door interrupter preferably provides more complete coverage to minimize the possibility of an approaching body avoiding detection.

Some door interrupters comprise an antenna that creates an electromagnetic field along the leading edge of a vertically operating door. When a nearby body disturbs the field by coming within a few inches of it, the door interrupter may respond by stopping or reversing the closing action of the door. Since the antenna, and thus its field, moves up and down with the leading edge of the door, somebody may be tempted to “beat the door” by racing underneath a closing door before the interrupter can sense their presence.

Some reliable door interrupters have a horizontal activation line or beam that is about 24-inches above the floor and extends completely across the width of the doorway. So, anything taller than the height of the activation line would have to trigger the door interrupter upon passing through the doorway. Since activation lines of such door interrupters typically lie immediately adjacent to the door, an approaching body typically will not trigger the interrupter unless the body is within or right next to the doorway.

Occasionally, a remote body detector may malfunction. If this occurs, the problem may go unnoticed while the door continues operating. Some detectors are self-monitoring and can provide an alarm signal in response to certain situations. U.S. Pat. No. 5,093,656, for example, discloses a motion-detection system that monitors a “quiet time” between signals to determine whether the device is continuously activated due to a noisy receiver. Similarly, U.S. Pat. No. 5,151,682 discloses an infrared sensor arrangement that monitors noise signals between actuations, wherein the noise signals are at a level below the threshold required to trigger the device. Such self-monitoring devices, however, can be expensive and may not provide all the features and benefits that other detectors can offer. Consequently, there is a need to have an ability to monitor various types of remote body detectors and to determine when they may be malfunctioning.

### SUMMARY OF THE INVENTION

In some embodiments, various door-related events are counted in some way, and the counts are then compared to obtain a physically meaningful result or results. The physically meaningful result or results are then evaluated relative to a limit or limits to determine the potential malfunction of a given component. Appropriate action can then be taken based on that determination.

In some embodiments, the door-related events are the actuations of the detector or detectors being monitored, which detectors may be unreliable in the sense defined herein.

In some embodiments, the door-related events are more inherently reliable events, such as the activation of a pull cord or push button.

In some embodiments, the counting step may include the counting of time (e.g. seconds) between or since certain events.

In some embodiments, the steps of counting and comparing to obtain a physically meaningful result are combined by coupling at least two events and/or the counting thereof.

In some embodiments, the appropriate action taken based on the determination is the activation of an alarm.

In some embodiments, the functioning of a remote body detector is monitored by comparing the activity of the detector to occurrences of a door-related event.

In some embodiments, the functioning of a remote body detector for a door is monitored by comparing the activity of the detector to occurrences of a door-related event in the form of the activity of another detector.

In some embodiments, the functioning of a remote body detector is monitored by counting the actuations of the detector.

In some embodiments, the functioning of a remote body detector is monitored by measuring how much time has elapsed since the detector was last actuated.

In some embodiments, the functioning of a remote body detector is monitored by determining whether the detector is actuated within a certain period of when a door-related event occurs.

In some embodiments, the functioning of a remote body detector is monitored by determining whether the detector has been inactive for an extended period during which a door-related event has occurred at least once.

In some embodiments, the functioning of a remote body detector is monitored by counting how many times a first detector has been actuated since the last time a second detector was actuated.

In some embodiments, the functioning of a remote body detector is monitored by counting how many times a door-related event has occurred since the last time the detector was actuated.

In some embodiments, the functioning of a remote body detector is monitored by determining whether one detector is activated repeatedly for at least a certain number of occurrences while another detector remains inactive.

In some embodiments, counting and comparisons are mode on more than two door-related events or detector actuations.

In some embodiments, the functioning of a remote body detector is monitored by comparing the activity of the detector within a given time period to a predetermined acceptable range of activity.

In some embodiments, a door is allowed to continue operating when a detector is only suspected of malfunctioning.

In some embodiments, a remote body detector does not affect the operation of a closed door.

### BRIEF DESCRIPTION OF THE DRAWINGS

FIG. 1 is a front view of a door showing various possible locations where a remote body detector may be mounted.

FIG. 2 is a general algorithm that illustrates how a remote body detector can be monitored for proper operation.

FIG. 3A is an algorithm that illustrates how a remote body detector can be monitored for proper operation.

FIG. 3B is another algorithm that illustrates how a remote body detector can be monitored for proper operation.

FIG. 4A is another algorithm that illustrates how a remote body detector can be monitored for proper operation.

FIG. 4B is another algorithm that illustrates how a remote body detector can be monitored for proper operation.

FIG. 4C is another algorithm that illustrates how a remote body detector can be monitored for proper operation.

FIG. 4D is another algorithm that illustrates how a remote body detector can be monitored for proper operation.

FIG. 5A is another algorithm that illustrates how a remote body detector can be monitored for proper operation.

FIG. 5B is another algorithm that illustrates how a remote body detector can be monitored for proper operation.

FIG. 6 is another algorithm that illustrates how a remote body detector can be monitored for proper operation.

### DESCRIPTION OF THE PREFERRED EMBODIMENT

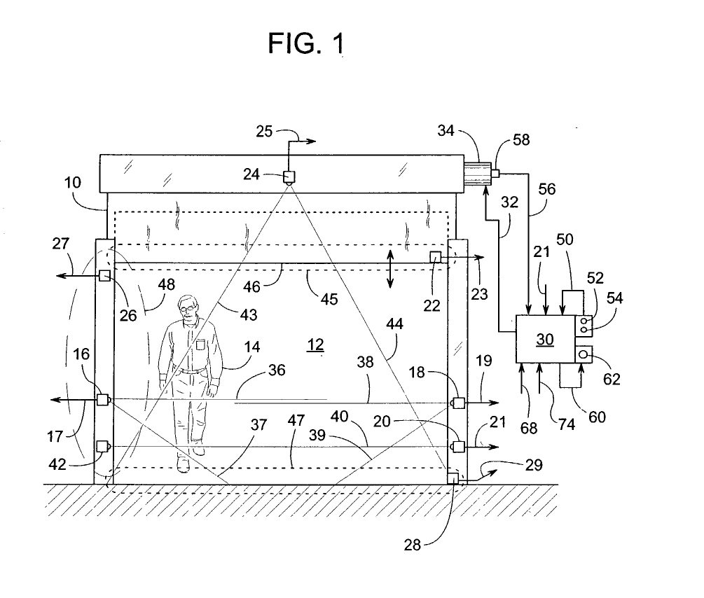

Referring to FIG. 1, a door 10 at a doorway 12 is provided with a detection system that helps prevent door 10 from accidentally closing on a nearby body 14, such as a person or object. The term, “doorway” refers to a plane defined by the path of the door's travel. The system comprises at least one remote body detector, such as detector 16, 18, 20, 22, 24, 26 or 28. Typically, a single door does not have as many detectors as shown in FIG. 1; the numerous detectors are shown as examples. A more typical door installation would include just one, two or just a few detectors in various combinations.

Each detector has at least one activation line that when disturbed by body 14 the detector associated with the disturbed line provides a signal. In response to body 14 crossing, obstructing, interrupting or otherwise disturbing an activation line while door 10 is not completely closed, the corresponding detector provides its signal for use as an input to a controller 30. Controller 30 may respond to the input by providing an output 32 to a drive unit 34 or respond in other ways. Drive unit 34 normally powers door 10 open and closed in a conventional manner but can also inhibit the closing of door 10 in response to output 32, for example by stopping or reversing the door's travel.

The various detectors are schematically illustrated to represent any remote body detector that may operate under various principles to create an activation line. The term, “activation line” refers to any line in space that when sufficiently disturbed creates a response in a detector associated with the line. The term, “disturbed” refers to changing some aspect of an established activation line. Examples of disturbing an activation line include, but are not limited to, obstructing, reflecting, absorbing, radiating, illuminating, and interfering. Examples of operating principles under which the various illustrated detectors may operate include, but are not limited to, ultrasonics; active and passive detection of infrared radiation; detection of electromagnetic radiation (including sensing radio waves or sensing changes in capacitance or inductance); and detecting a Doppler shift in microwaves; and lasers. One particular example of remote body detector is a passive infrared device, such as a VX-402 provided by Optex Incorporated, of Torrance, Calif. Further information about remote body detectors can be found in U.S. Pat. Nos. 4,612,442; 5,703,368 and 5,986,265, which are specifically incorporated by reference herein.

In cases where a detector is not self-monitoring (i.e., the detector itself does not have a means for determining whether it is functioning properly), controller 30 may use one or more of signals 17, 19, 21, 23, 25, 27 or 29 to determine whether a detector may have failed or otherwise be malfunctioning. For the illustrated detectors, signal 19 and activation lines 36 and 37 are associated with detector 16, signal 19 and activation lines 38 and 39 are associated with detector 18, signal 21 and a beam 40 (one example of an activation line) are associated with detector 20 plus its related hardware 42 (a beam receiver or reflector), signal 25 and activation lines 43 and 44 are associated with detector 22, signal 23 and activation line 45 (electromagnetic field adjacent a leading edge 46 of the door), signal 29 and activation line 47 (electromagnetic field adjacent a threshold of the door), signal 27 and activation line 48 (electromagnetic field adjacent a side frame member of the door), are associated with detector 26. In addition to signals 17, 19, 21, 23, 25, 27 or 29, controller 30 may consider various other inputs, which may include, but are not limited to, a door actuation signal 50 (e.g., from a door operator switch 52 that opens the door or from a door operator switch 54 that closes the door) and feedback 56 from a limit switch assembly 58 that identifies various door positions (e.g., door fully open, door fully closed, or an intermediate door position).

In order for controller 30 to evaluate the functioning of one or more detectors, controller 30 should be capable of performing a logical analysis of certain inputs, which can be achieved with various types of controllers. Thus, controller 30 is schematically illustrated to represent any such controller. Examples of controller 30 include, but are not limited to, a computer, microprocessor, PLC (programmable logic controller), digital circuitry, analog circuitry, relay circuitry, and various combinations thereof. To monitor the functional condition of one or more detectors, controller 30 may employ any one of various algorithms, which can be timer-based, counter-based, or a combination of the two.

In this description, any of signals 17, 19, 21, 23, 25, 27, 29, 50, 56 and other similar signals may be referred to as “door-related signals” and the underlying events generating such signals as “door-related events.” It will be appreciated that the signals associated with the various detectors may be less reliable than the signals associated with the other hardware—such as signal 50 for a door operator switch. While we have selected reliable detectors for use in our doors, we also appreciate that detectors can malfunction for a variety of reasons (e.g. lenses can become clouded or dirty, or electronics or hardware can fail), and are thus referring to the detectors as “unreliable” in that sense. In addition, these detectors may be considered “unreliable” in the sense that they are not self-monitoring in that one cannot determine whether a given detector is operating properly just from looking at its output. Given that “unreliability,” we have developed the monitoring schemes herein to compare various door-related events to determine whether a given detector may be malfunctioning. Toward that end, in some embodiments, the activations of two or more detectors are compared to each other. But in other embodiments, the activation of a given detector is compared to a more “reliable” signal such as signal 50. By properly selecting the algorithms by which various door-related events are counted, and those events compared and the results evaluated, one can determine the possibility or probability that a given detector has malfunctioned, and take appropriate action, such as initiating an alarm and/or suspending door operation.

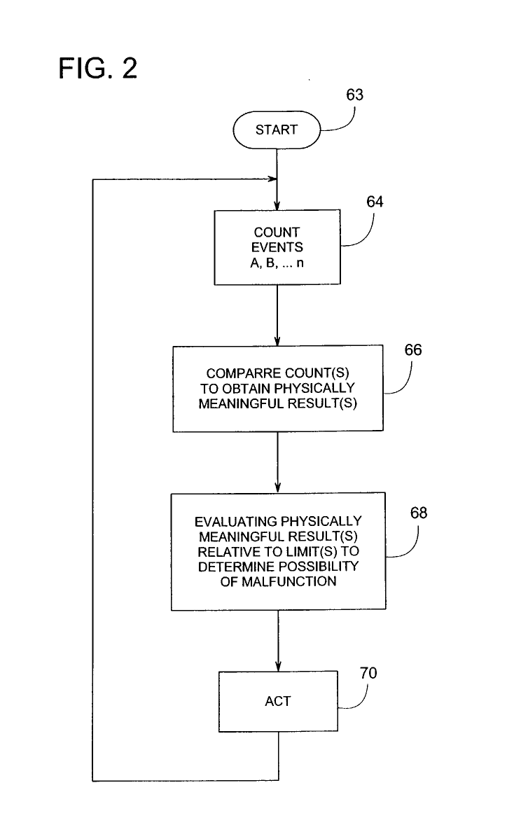

The general flow for such algorithms can be found in FIG. 2. After initiation of the algorithm is START block 63, functional block 64 “counts” door-related events. The count may be of a single door related event (herein, generally referred to as a “DRE”) A, or several DRE's A, B, . . . up to an undetermined number n may be counted (the counting of which may require multiple counters). As will be appreciated from the remainder of this description, the term “count” should be construed broadly, as it may encompass one or more of the following: 1) incrementing a counter by 1; 2) incrementing a counter by a number other than 1; 3) decrementing a counter (by 1 or another number); 4) re-setting a counter (e.g. decrementing a counter to zero); 5) “counting” time (for example by running a timer), etc. Once the “counts” have been obtained, the various counts are then compared in functional block 66 to obtain a physically meaningful result or results. The physically meaningful result or results may take several forms depending on the specific algorithm being employed. Examples include: the value of a counter, the difference between values of counters, the value of a timer, and the difference between timer values. In short, the “physically meaningful result” represents some physical reality—such as the fact that two “redundant” detectors did not activate together as expected one or more times. The algorithm thus has to be constructed to reflect the physical reality of interest based on the given inputs.

The general algorithm then proceeds with functional block 68, which evaluates the physically meaningful result or results against a limit or limits. Returning to the example of “redundant” detectors not activating together—such an event may illustratively be acceptable once or twice, but not more than twice. By comparing the physically meaningful result representative of the physical reality to a limit (in this case, the number 2), it can be determined that one of the detectors may be malfunctioning. Accordingly, the algorithm continues by taking appropriate action (block 70) based on the evaluation done in block 68. Given that a potential malfunction of a detector has been identified, appropriate action may include initiating an alarm and/or suspending further operation of the door.

The general algorithm described in reference to FIG. 2 will now be exemplified in reference to the particular embodiments thereof depicted in the figures.

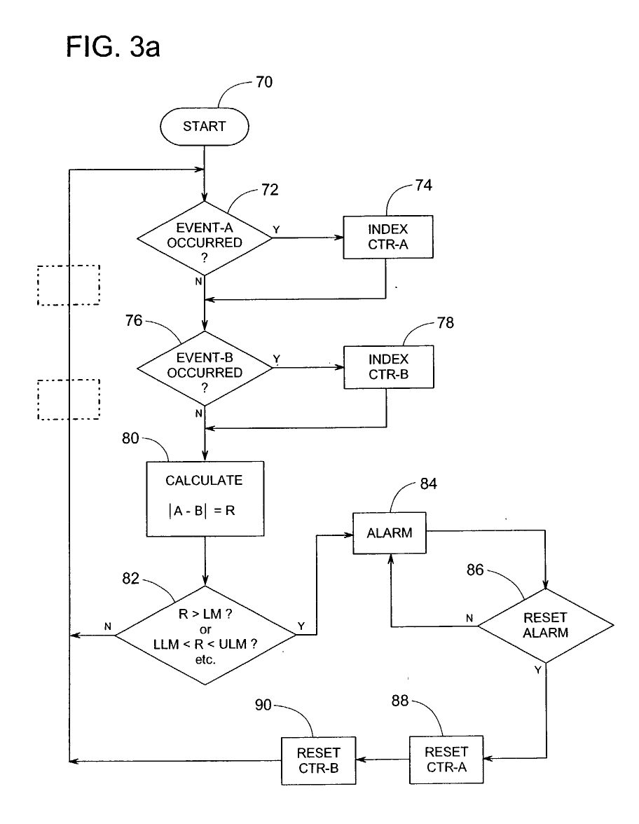

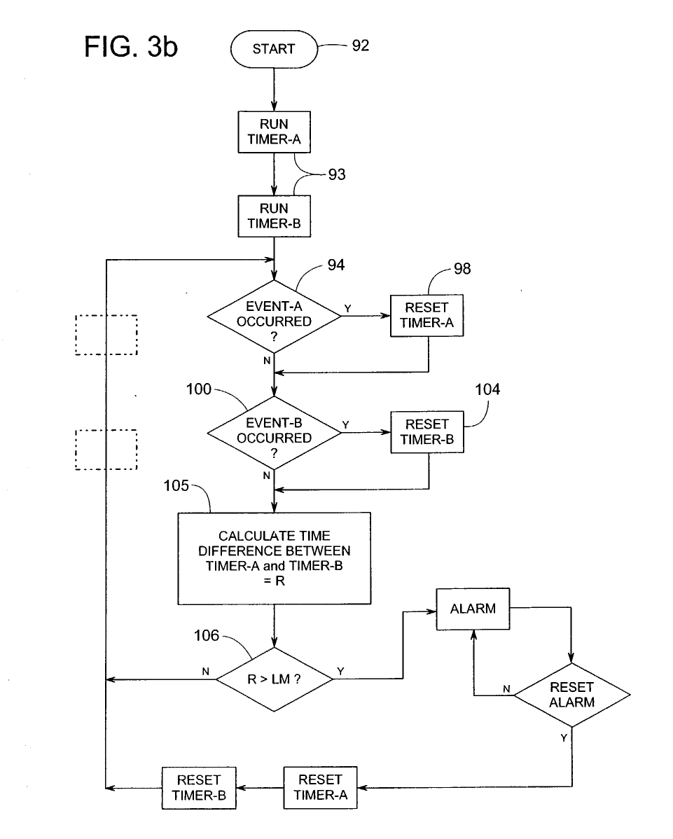

In the first set of examples (FIGS. 3A-3B), two DRE's are counted, and the difference between those “counts” are then determined in the comparison step to obtain a physically meaningful result. This result is then compared to a limit and appropriate action taken.

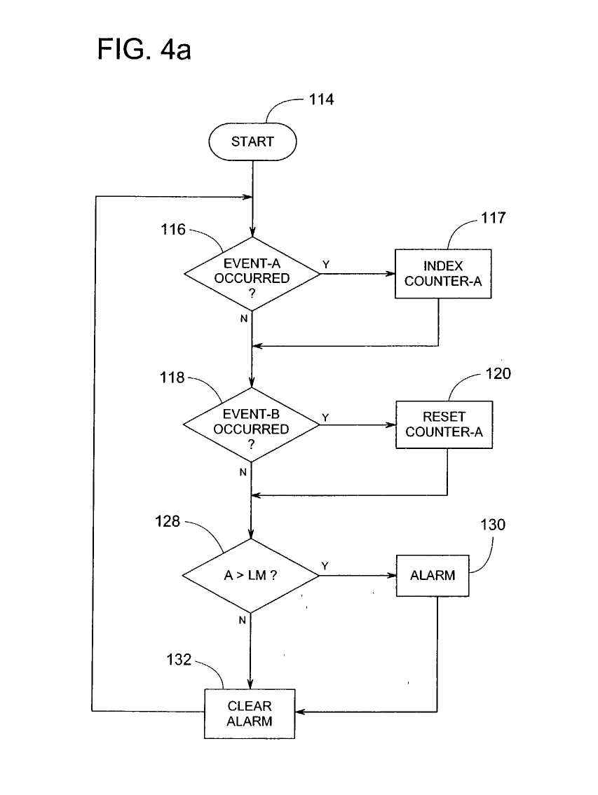

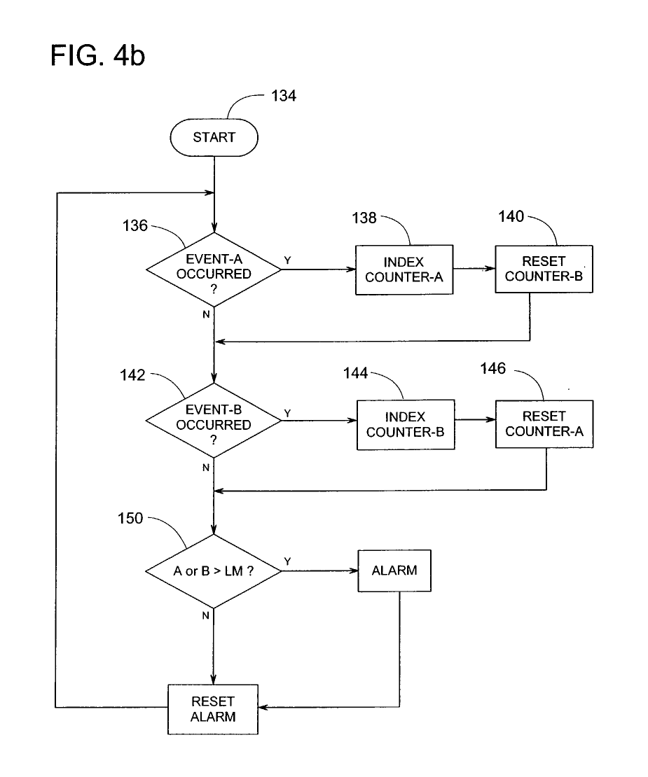

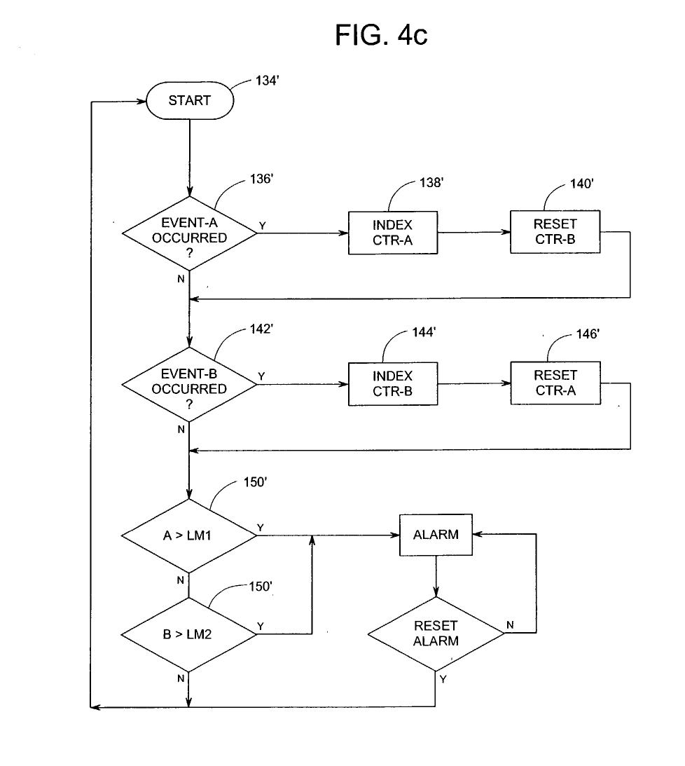

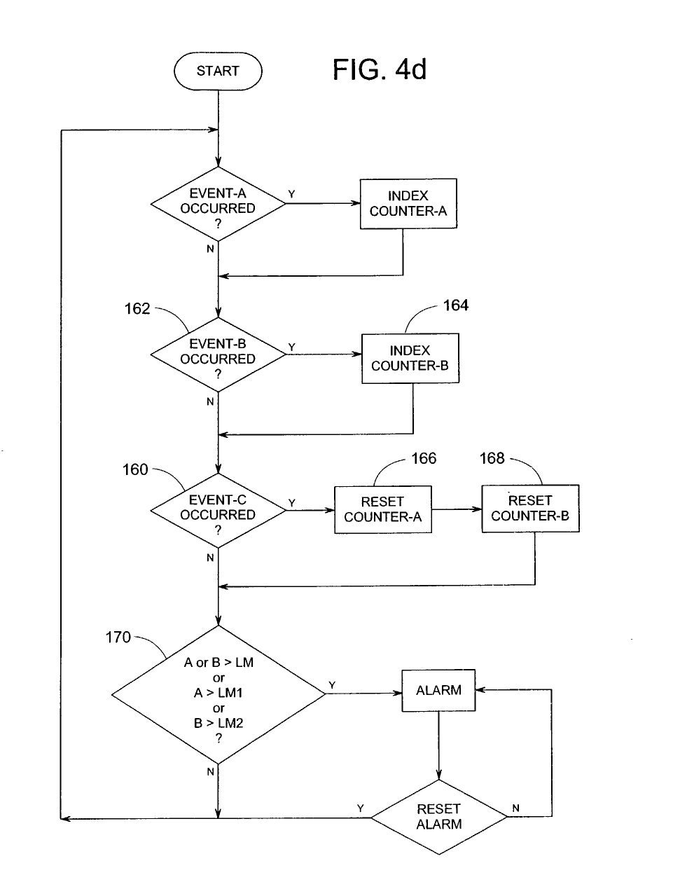

FIG. 3A illustrates a basic counter-based algorithm where a potential fault is identified by comparing the number of occurrences of one detector to that of another detector or another door-related event. A start block 70 begins the process at block 72, which determines whether an event-A has occurred, and a counter-A in block 74 counts the events. As shown in the figures, this “counting” is referred to as “indexing” of counter-A to indicate that the term “count” broadly encompasses incrementing or decrementing a value, or other actions, based on the occurrence of an event. The term, “occurrence” refers to an event happening, such as an activation line of a detector being disturbed by body 14. For example, if signal-A is signal 17 from detector 16, then an occurrence of signal-A maybe activation lines 36 and 37 being sufficiently disturbed to cause detector 16 to generate signal 17, which would be wired to input 68. The terms, “signal-A” and “signal-B” each represent any input to controller 30. Examples of signal-A and signal-B include, but are not limited to, signals 17, 19, 21, 23, 25, 27, 29, 50, and 56. Likewise, block 76 determines whether an event-B has occurred, and a counter-B in block 78 counts those events by indexing. In block 80, the count values of counter-A and counter-B are compared, thereby obtaining an actual comparison. If both counters of blocks 74 and 78 are incremented with each event, then the actual comparison can be the difference between their count values. This is depicted in the figure by decision block 80 calculating a value “R” equal to the absolute value of the difference A-B. If one of the counters, however, is an up-counter that increments with each occurrence while the other counter is a down-counter that decrements with each occurrence, then the actual comparison may be a sum of their count values. The increment/decrement method will be explained later with reference to FIG. 4C.

The value “R” is the physically meaningful result previously discussed. If, for example, event A is activation of detector 16, and event B is activation of detector 18 (FIG. 1) value R represents the difference in the number of times these detectors were activated. Given that these detectors are similarly placed on either side of the door, and assuming they are both monitoring the entire opening, one might expect that under normal circumstances that the difference R would be zero, since anything activating 16 would activate 18 as well. In a similar vein, event A could be activation of a detector 16, and event B could be activation of door operator switch 52, generating signal 50 (FIG. 1). Under normal door conditions, one might expect that once the switch 52 is actuated (to cycle the door open and closed), that the detector 16 would then be activated as someone passed through the opening. Accordingly, one might again expect R to normally be zero. By evaluating the physically meaningful result R against a predetermined limit, the seriousness of the discrepancy represented thereby can be evaluated.

Regardless of how the actual comparison is achieved, block 82 of FIG. 3A compares the physically meaningful result R to a limit LM. The term “limit” should be broadly construed to encompass not only a specific limit, but also a range of values as depicted in block 82. A block 84 triggers alarm 62 if R is outside the limit. The term, “outside the limit” generally means that R deviates from the limit (i.e., greater than or less than the limit). In this specific example, however, R is evaluated as being less than a limit LM, or as being between a lower limit LLM and an upper limit ULM. Once block 84 activates alarm 62, the alarm may remain active until the alarm is automatically or manually reset by block 86. Such reset may occur by virtue of the controller 30, or it may preferably be operator-controlled, such as by pushing a “reset” button. This has the advantage of allowing the alarm to signal a potential detector malfunction to the operator to allow him to take corrective action (e.g. check the detector or detection system) before clearing or resetting the alarm. If the alarm is reset or if block 82 does not identify a potential fault, then blocks 88 and 90 reset the counters, and the logic returns to block 72 to repeat the process. Blocks 88 and 90 are also repeated in phantom in the return line from block 82 to block 72 to indicate that it may be desirable to re-set the counters A and B even if the evaluation of value R relative to the limit was not outside of the limiting condition. This applies throughout the figures, as in certain operational circumstances, it will be useful to reset some or all counters or timers when looping the algorithm in this way.

The algorithm of FIG. 3B is timer-based in that a potential malfunction of a detector is identified when one detector is activated repeatedly over an elapsed time while another detector is inactive during that same period. Stated another way, the algorithm of FIG. 3B compares the time elapsed since each of the last occurrences of events A and B. A large enough gap between the two may be indicative of a malfunction of one or the other. For example, for “redundant” detectors (monitoring the same space from different locations, for example) one would normally expect little delay between activations. The magnitude of the delay between the two is thus a physically meaningful result, in that a large delay may indicate that one or the other detectors is malfunctioning.

Start block 92 begins the logic at blocks 93, which runs timers A and B, and then proceeds to decision block 94, which looks for occurrence of signal-A. If signal-A occurs, decision block 94 directs the logic to block 98, which resets timer-A to a reset value (e.g., zero for an up-counter or a certain value for a down-counter). Otherwise, counter-A simply continues to run. Likewise, decision block 100 looks for occurrence of signal-B. If signal-B occurs, decision block 100 directs the logic to block 104, which resets timer-B to its reset value. Next, block 105 calculates a physically meaningful result R. Block 106 then determines whether this time discrepancy R is significant by evaluating that value against a limit. If the difference between timer-A and timer-B (“R”) is greater than a predetermined limit (period of time), then block 108 activates alarm 62. The clearing or resetting of the alarm is then as described in regard to FIG. 3A.

The embodiments of FIGS. 4(A-D) introduce a technique by which the counting and comparing steps of the general algorithm (i.e blocks 64 and 66 of FIG. 2) are, in effect, collapsed together. This is achieved by “coupling” the separate events A and B (and perhaps others) and/or the counting thereof. As will be seen from the examples, by coupling the events or related counts in this way, the resulting counts are physically meaningful in the sense of themselves being indicative of a potential detector malfunction. By way of comparison, in the embodiments of FIG. 3, the counts (or times) taken had to be compared to each other to get physically meaningful results (see blocks 80 and 105). Coupling eliminates the need for such a comparison. Rather, the value of a given counter can be compared directly to a limit.

In the algorithm of FIG. 4A, controller 30 determines whether a detector has been inactive for an extended period during which a door-related event has occurred at least once. The term, “door-related event” refers to the occurrence of any particular action that is associated with a door. Examples of door-related events include, but are not limited to opening the door, closing the door, actuating limit switch assembly 58 (FIG. 1), actuating a switch or device that is intended to open or close the door (e.g., switch 52 or switch 54 of FIG. 1), tripping a photoelectric eye (e.g., detector 20), actuating another remote body detector, etc. Although such a detector monitoring scheme can assume various forms, the algorithm of FIG. 4A receives input from a signal-A which is illustratively signal 50 from switch 52, and a signal-B, illustratively from the detector 16 which is being monitored.

The process begins with a start block 114 directing the logic to block 116, which determines if there has been an occurrence of signal-A. If so, counter-A is indexed in 117. In block 118, occurrences of signal-B are evaluated. In response to an occurrence of signal-B, block 120 resets counter-A, and logic transfers to decision block 128. It is through the mechanism of resetting counter-A by an occurrence of event B that the “coupling” of events A and B and/or their respective counts occurs. Such a coupling yields a physically meaningful result (in this case the value of counter-A) without having to perform the separate step of comparing counters. Stated another way, the coupling here of A and B has allowed the counting and comparing steps to be performed simultaneously.

To clarify by an example, recall that signal-A represented a “door open” push button and signal-B represented an “unreliable” detector. According to the logic, counter-A keeps counting door openings until detector B detects a body in the opening. Since one would expect that once the door was opened (by activation of the push button) that someone would pass through the door and trip the detector, counter-A would normally toggle between 0 and 1 (assuming it started at zero and was always indexed by incrementing the count by 1). If, however, detector B is not functioning, counter-A will not get reset, and will continue to increment to larger and larger values. The value of counter-A is thus itself physically meaningful (representing the number of open-button pushes since the last detector B activation), and it need not be separately compared to the value of another counter to obtain physically meaningful (to detector monitoring) information.

Accordingly, the logic flow of FIG. 4A continues by decision block 128 determining whether the event count value of counter-A exceeds a predetermined limit (LM). If so, block 130 activates alarm 62 and the logic returns to block 116 after clearing of the alarm (manually or automatically) at 131. If the event count value of counter-A does not exceed the predetermined limit, then block 132 ensures that alarm 62 is cleared, and the logic transfers to block 116 to continue the detector monitoring process.

The algorithm of FIG. 4B also shows a coupling of counters A and B, and thus their underlying events. In this case, the occurrence of either event A or B resets the counter counting the other of events A and B. For this reason, this algorithm (and the substantially similar algorithm of FIG. 4C) may be particularly well suited to monitoring two “unreliable” sources (e.g. detectors) that one would normally expect to operate in tandem—such as the “redundant” detectors previously described.

For the algorithm of FIG. 4B, controller 30 identifies a potential problem when one detector is activated repeatedly for at least a certain number of occurrences while another detector remains inactive. The algorithm begins with START block 134 passing the logic to decision block 136, evaluating occurrences of event-A. If event-A occurs, block 138 indexes counter-A, and block 140 resets counter-B (illustratively to zero). If event-A does not occur, the logic passes directly to decision block 142, evaluating occurrences of event-B. If event-B occurs, block 144 indexes counter-B and block 146 resets counter-A. Because of the coupling of A and B (by virtue of their mutual reset of each other), both of the values of the counters represent physically meaningful results. If A is malfunctioning and B is operating normally, the value of counter-B will be incrementing while counter-A stays at zero, and vice-versa. Accordingly, the algorithm can proceed by decision block 150 directly evaluating the value of counter-A or counter-B to a limit LM. If the limit LM is exceeded (because one detector has been activated more times than the limit since the last activation of the other detector), the alarm/reset sequence follows. Otherwise, the algorithm loops to 136.

FIG. 4C is nearly identical to 4B, except that each of the values A and B have been compared to separate limits, and the alarm/reset sequence is different. Given this similarity, primed numbers as compared to 4B have been used. Comparing the A and B values to separate limits (LM1 and LM2, respectively) maybe useful if they are different kinds of detectors, or monitoring different areas. For example, certain detectors activate twice for a given passage of a detected body, while others activate only once for the same passage. In that same instance, of course, once could also compensate for this difference by incrementing one counter by 2's, and the other by 1's. Such a scheme falls within the general definition herein of the terms “count;” “index;” and/or “increment,” with such schemes being suggested or dictated by the specific application.

FIG. 4D is similar to FIG. 4A, but demonstrates the ability to expand the concepts herein beyond just two events. As comparison of FIGS. 4D and 4A will reveal, an additional event-C is being evaluated at block 160. Also, while event-B is being evaluated as in 4A (at 162), its occurrence occasions only an indexing of counter-B at 164. The occurrence of event-C, however, resets both counters A and B at 166, 168. Assuming that events-A and B are “reliable” DRE's, and that C is an “unreliable” DRE (such as a detection event), the values of counters A and B represent the physically meaningful value of the number of A and B events since the last detector activation. If the detector is not activating properly, these counts will continue to grow. Counts A and/or B can thus be directly compared to a limit and/or limits in decision block 170 to determine if detector C is potentially malfunctioning. If so, an alarm/reset sequence is initiated.

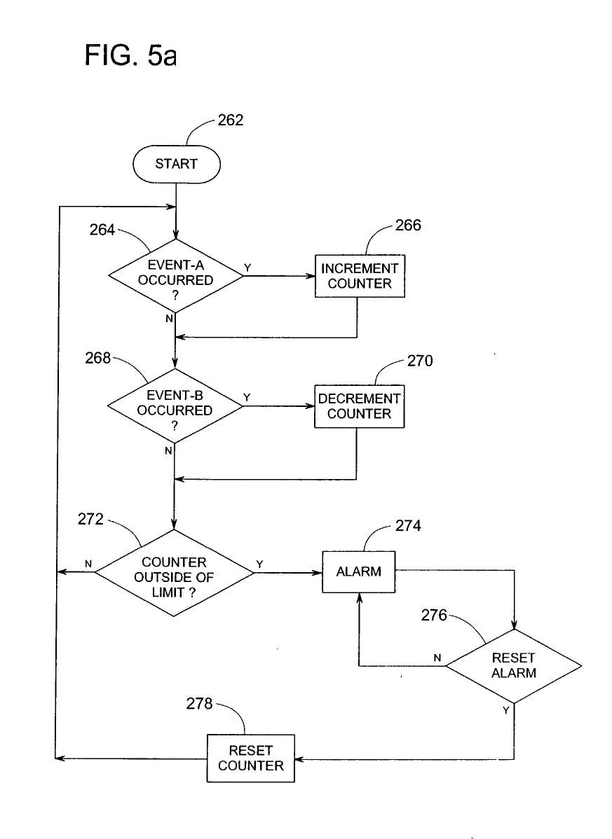

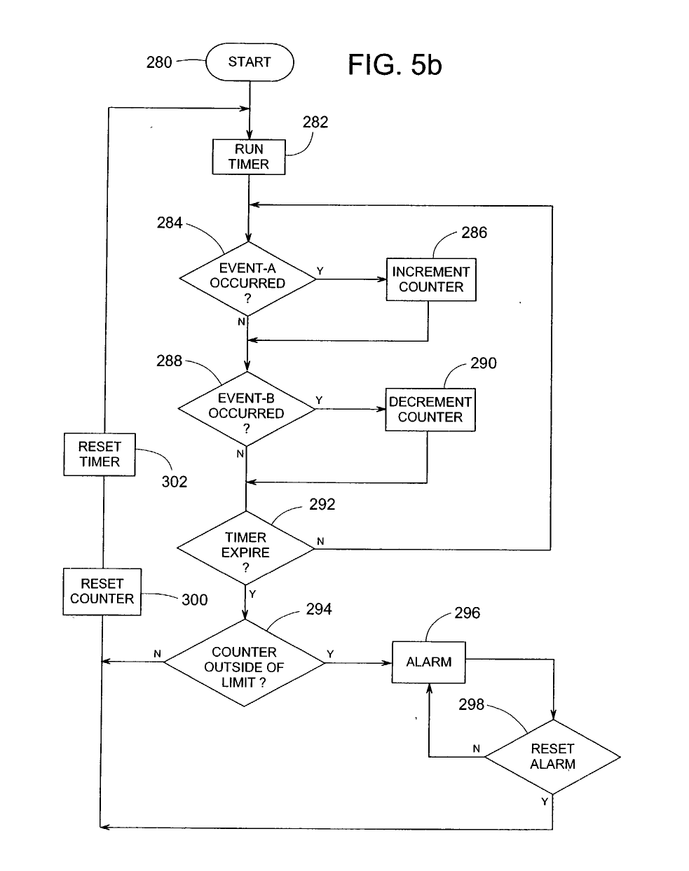

In the algorithm of FIGS. 5(A and B), coupling of events and/or counting thereof is achieved by a single counter being incremented by one door-related event and decremented by another. Thus, the counter's absolute value will grow with an imbalance between the two door-related events. Note that the single counter could be initiated with a non-zero initial value (e.g. 10,000) to avoid it having to handle negative numbers. Following start block 262, blocks 264 and 266 increment the counter with each occurrence of event-A, and blocks 268 and 270 decrement the counter with each occurrence of event-B. Since the counter's value represents an imbalance between event A and B occurrences, it is a physically meaningful result that can be evaluated relative to a limit to determine the potential of detector malfunction. Block 272 thus determines whether the counter's value is outside or beyond a predetermined limit. If the counter's value is beyond the limit, block 274 activates alarm 62 until block 276 manually or automatically resets the alarm. If the alarm is reset or block 272 does not identify a fault, then block 278 resets the counter, and the logic returns to block 264 to repeat the process. As before, the application may suggest that the value of the increment for A be different that that for B—to take into account the example where one detector type is expected to actuate twice as often as another, or like examples.

With sufficient time, the count value of the counter in FIG. 5A may eventually exceed the limit if the occurrences of event-A and event-B are slightly imbalanced. To avoid this, the algorithm of FIG. 5B includes a timer to provide a combined counter-based, timer-based system. The timer can be used to calculate a rolling average of the counter's value or simply acquire a count value over a given period. For example, a start block 280 can begin the process with block 282 starting the timer. While the timer is running, blocks 284 and 286 increment the counter with each occurrence of event-A, and blocks 288 and 290 decrement the counter with each occurrence of event-B. This increment/decrement process continues until block 292 determines that the timer has expired (exceeded a predetermined time limit). Upon the time limit expiring, block 294 determines whether the counter's value is outside or beyond a predetermined limit. If the counter's value is beyond the limit, block 296 activates alarm 62 until block 298 manually or automatically resets the alarm. If the alarm is reset or block 294 does not identify a fault, then block 300 resets the counter, block 302 resets the timer, and the process is repeated by returning the logic to block 282.

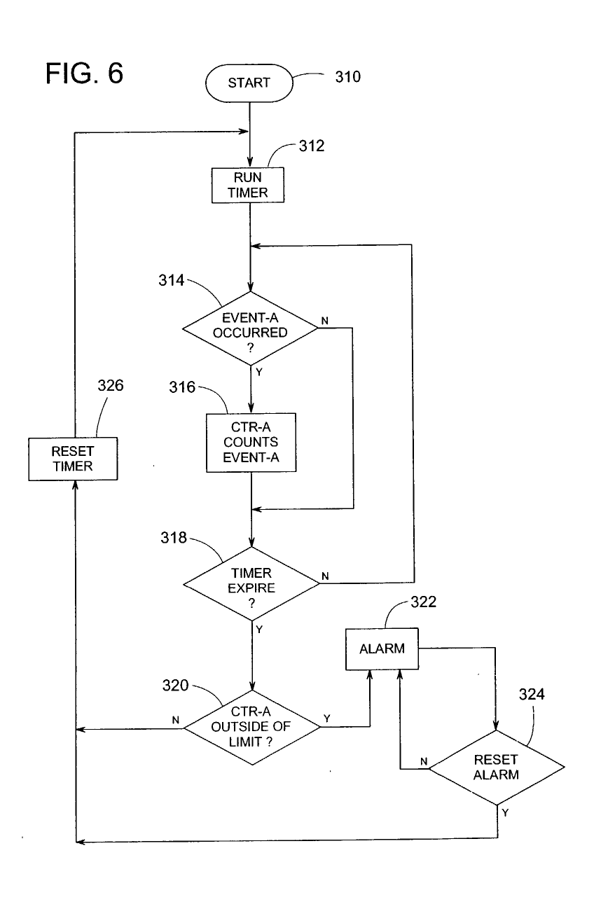

FIG. 6 illustrates a basic timer-based algorithm where a potential fault is identified based on a detector being triggered or some other door-related event occurring or failing to occur within a predetermined period. While the algorithm of FIG. 6 does not necessarily represent a coupling of events, as in FIGS. 4 and 5, the value of counter-A nonetheless itself represents a physically meaningful result, in that it specifies the number of A-events within a specified time period. Toward that end, start block 310 begins the process at a block 312, which starts a timer. Next, block 314 determines whether event-A has occurred, and if it has, a counter-A counts the event in block 316. Counter-A may be an up-counter or a down-counter. Once the predetermined period has expired, as determined by a block 318, a decision block 320 determines whether the physically meaningful count value of counter-A is outside a certain limit. The term, “outside a limit” means that the count value deviates from the limit (i.e., greater than or less than the limit). For example, a potential detector fault may be identified as a detector being too active or unusually inactive. Upon block 320 identifying a potential fault, block 322 activates alarm 62 until block 324 automatically or manually resets the alarm. If the alarm is reset or if block 320 does not identify a potential fault, then block 326 resets the timer and returns the logic to block 312 to repeat the process.

There has thus been described examples of algorithms that can be used in combination with door hardware to provide for monitoring of detectors that are not self-monitoring. Counters are employed to count events, and these counts are compared—sometimes with the counting and comparing steps being combined by coupling as defined herein. Either way, the resulting physically meaningful quantity(ies) can then be compared to a limit or limits to determine the potential for detector malfunction. Appropriate action can then be taken based on that determination.

Although the invention is described with respect to a preferred embodiment, modifications thereto will be apparent to those skilled in the art. Therefore, the scope of the invention is to be determined by reference to the claims, which follow.

We claim:

1. A method of operating a detection system of a door at a doorway, wherein the detection system includes a first remote body detector and a second remote body detector each of which are adapted to be triggered by a body adjacent to the doorway, wherein the first remote body detector may provide a signal-A with each occurrence of the first remote body detector being triggered, and the second remote body detector may provide a signal-B with each occurrence of the second remote body detector being triggered, the method comprising:
comparing the occurrences of signal-A to the occurrences of signal-B; and
providing an alarm signal in response to comparing the occurrences of signal-A to the occurrences of signal-B.

2. The method of claim 1, further comprising:
counting the occurrences of signal-A to obtain a signal-A count value;
counting the occurrences of signal-B to obtain a signal-B count value; and
comparing the signal-A count value to the signal-B count value.

3. The method of claim 2, wherein the alarm signal is provided when a difference between the signal-A count value and the signal-B count values exceeds a predetermined limit.

4. A method of operating a detection system of a door at a doorway, wherein the detection system includes a first remote body detector that is adapted to be triggered by a body adjacent to the doorway, wherein the first remote body detector may provide a signal-A with each occurrence of the first remote body detector being triggered, the method comprising:
establishing a certain time period;
counting a number of occurrences of signal-A within the certain time period;
comparing the number of occurrences of signal-A to a limit; and
providing an alarm signal in response to the number of occurrences of the signal-A being outside the limit.

5. The method of claim 4, wherein the alarm signal is provided in response to the signal-A being less than the limit.

6. The method of claim 4, wherein the alarm signal is provided in response to the signal-A being greater than the limit.

7. The method of claim 4, further comprising permitting ongoing operation of the door when the alarm signal exists.

8. A method of monitoring a detection system of a door at a doorway where a door-related event may occur repeatedly, wherein the detection system includes a first remote body detector that is adapted to be actuated by a body adjacent to the doorway, wherein the first remote body detector may provide a signal-A with each occurrence of the first remote body detector being actuated, the method comprising:
counting a first quantity of occurrences of the door-related event;
counting a second quantity of occurrences of the signal-A;
comparing the first quantity to the second quantity, to obtain a physically meaningful result;
establishing a limit;
comparing the physically meaningful result to the limit; and
providing an alarm signal in response to the physically meaningful result being outside the limit.

9. The method of claim 8, wherein the alarm signal is provided in response to the physically meaningful result being less than the limit.

10. The method of claim 8, wherein the alarm signal is provided in response to the physically meaningful result being greater than the limit.

11. The method of claim 8, wherein the counting and comparison steps are combined by coupling the counting of the first quantity of occurrences of the door-related event to the counting of the second quantity of occurrences of the signal-A, thereby making at least the second quantity a physically meaningful result.

12. The method of claim 11, wherein the coupling is achieved by using an occurrence of the door-related event to reset the counting of occurrences of signal-A.

13. The method of claim 11, wherein the coupling is achieved by incrementing a counter in response to the signal-A and decrementing the counter in response to the door-related event occurring.

14. The method of claim 8, wherein the door-related event is the actuation of a second remote body detector.

15. A method of monitoring a detection system of a door at a doorway where a plurality of door-related events may occur, the method comprising:
counting a first quantity of occurrences of a first door-related event;
counting a second quantity of occurrences of a second door-related event;
comparing the first quantity to the second quantity, to obtain a physically meaningful result;
establishing a limit;
comparing the physically meaningful result to the limit; and
taking appropriate action based on the physically meaningful result being outside the limit.
